(19) United States
(12) Patent Application Publication
(10) Pub. No.: US 2026/0059252 A1
(43) Pub. Date: Feb. 26, 2026

(54) ACOUSTIC IMAGE ENHANCEMENT FOR STEREO AUDIO

(71) Applicant: Dolby International AB, DUBLIN (IE)

(72) Inventors: Giulio Cengarle, Barcelona (ES); Davide Scaini, Girona (ES)

(73) Assignee: Dolby International AB, DUBLIN (IE)

(21) Appl. No.: 18/998,839

(22) PCT Filed: Jul. 25, 2023
(86) PCT No.: PCT/EP2023/070625

§ 371 Date: Jan. 27, 2025

Related U.S. Application Data
(60) Provisional application No. 63/421,918, filed on Nov. 2, 2022.
(60) Provisional application No. 63/491,514, filed on Mar. 21, 2023.

(30) Foreign Application Priority Data
Jul. 28, 2022 (ES) P202230692

(51) Int. Cl. H04S 7/00

(52) U.S. Cl. CPC H04S 7/301

(57) ABSTRACT

The present disclosure relates to a method and system for processing stereo audio signals. The method comprises obtaining a stereo input audio signal and determining at least one acoustic image metric of the input audio signal wherein the at least one acoustic image metric indicates a channel level difference and/or channel the input audio signal. The method further comprises obtaining a target acoustic image metric being determined from a set of reference stereo audio signals and determining an audio processing scheme to be applied to decrease the difference metric. The method also comprises processing the input audio signal with the audio processing scheme to obtain a processed audio signal.

### CROSS REFERENCE TO RELATED APPLICATIONS

This application claims priority to Spanish Patent Application No P202230692, filed 28 Jul. 2022 and U.S. provisional application No. 63/421,918, filed 2 Nov. 2022 and 63/491,514, filed 21 Mar. 2023, all of which are incorporated herein by reference in their entirety.

### TECHNICAL FIELD OF THE INVENTION

The present invention relates to a stereo audio processing method, and a stereo audio processing system, for enhancing a stereo image of an input audio signal.

### BACKGROUND OF THE INVENTION

The stereo audio format is by far the most common format used in music production. Additionally, the stereo audio format is also used to a large extent for other types of audio content such as speech recordings or video soundtracks. A stereo audio signal comprises a pair of sub-signals, also referred to as channels, and commonly a left and right channel intended for a left and right loudspeaker or earbud. When professionally recording stereo audio, the stereo audio signal is first recorded and mixed prior to being “mastered.” The mastering process involves an experienced audio engineer using accurate tools and a carefully designed listening environment to adjust the stereo audio signal (e.g. channel leveling, equalization and filtering) to produce a final version of the stereo audio signal. When adjusting the stereo audio signal, the engineer considers a variety of factors, for instance the final stereo audio signal may be required to conform to professional standards and be suitable for playback on many different devices used in different environments, such as radio broadcasting, earphones and stereo loudspeakers.

When mastering stereo audio content the properties of what often is referred to as the stereo image properties of the stereo audio signal are of primary importance. “Stereo image properties” refer to the apparent or observed spatial qualities of the audio signal when rendered in a listening environment. The apparent spaciousness, also referred to as the stereo width, the inter-channel phase difference and the panning of the stereo audio signal are examples of stereo image properties.

During mastering, engineers process the stereo recording to e.g. achieve a proper balance between the channels, a suitable phase relationship and an appropriate stereo width considering the type of audio content (e.g. the type of music). For example, it generally holds that at low frequencies classical music benefits from a large stereo width whereas other types of music, such as rock or pop, benefits from a narrower stereo width.

Accordingly, by manually mastering professionally-recorded stereo audio signals, professional audio content is generated which is suitable for playback on a wide spectrum of devices in different environments.

### GENERAL DISCLOSURE OF THE INVENTION

A drawback with the existing solutions for generation of professionally mastered stereo music is that the process is labor intensive and requires highly specialized engineers trained to operate expensive equipment. To this end, much music content that is recorded by semi-professionals or amateurs, often referred to as User Generated Content (UGC), is distributed without mastering, meaning among other things that the stereo image properties have not been properly adjusted. Due to e.g. the increased spread of amateur recording devices (e.g. in smartphones or computers) UGC has over the last decades become much more widespread and currently UGC is consumed at a rate similar to or even exceeding the rate at which professionally generated content, PGC, is consumed. As a consequence, much of the stereo audio content consumed today has undergone no mastering, or only a very basic form of automatic mastering, and may feature sub-optimal or directly unsuitable stereo imaging properties.

For example, amateur recordings of stereo music often feature a too wide or too narrow stereo width considering the type of audio content (e.g. type of music) that has been recorded, an improper channel balance or improper inter-channel phase relationship. The latter may e.g. result in stereo audio signals that are perceived as “phasey”, a term that is commonly used to describe the odd sensation produced to a listener by anomalies in the phase relationship between the channels of the stereo audio signal, especially in the low- and mid-range frequency bands.

In view of the above, it is apparent that there is a need for an improved method for processing stereo audio signals to enhance the stereo image properties without necessitating an experienced mastering engineer to manually process the stereo audio signal.

Another drawback with traditional mastering techniques is that the available tools have limited capabilities to restore and enlarge a too-narrow stereo image.

According to a first aspect of the invention there is provided an audio processing method, the method comprising obtaining a stereo input audio signal comprising a specific type of audio content and determining, from at least one frequency band of the input audio signal, at least one acoustic image metric of the input audio signal, the at least one acoustic image metric indicating a channel level difference and/or correlation between the two channels of the stereo input audio signal in the at least one frequency band. The method further comprises obtaining, for each frequency band, a target acoustic image metric, the target acoustic metric being determined from a set of reference stereo audio signals, each reference audio signal comprising the specific type of audio content and determining, for each frequency band, a difference metric based on a difference between the acoustic image metric and the target acoustic image metric. Additionally, the method comprises determining, for each frequency band and based on said difference metric, an audio processing scheme to be applied to decrease the difference metric and processing, each frequency band of the input audio signal with the audio processing scheme to obtain a processed audio signal.

By comparing the extracted acoustic image metric with the target acoustic image metric (that is based on reference audio content) an automatic stereo mastering method is obtained which is accurate and automatic, with less, or no, user interaction. The automatic stereo mastering method works well across a wide range of input audio signals irrespective of how large the difference in acoustic image metric is between the input audio signal and the target acoustic image metric. If the difference is small, the input audio signal is processed less aggressively, and a portion of the processing may e.g. be bypassed in some frequency bands where the input audio signal is deemed sufficiently close to the target acoustic image metric from the start. Additionally, the automatic stereo mastering method is capable of mastering input audio signals that are very different from the reference audio content associated with the target acoustic image metric. For example, in an extreme scenario the input audio signal is a mono audio signal and the target acoustic image metric is associated with a spacious (wide) stereo audio content. With the automatic stereo mastering method described in the above an audio processing scheme will be determined automatically, producing a processed audio signal that is similar in terms of acoustic image properties to the reference audio content despite the source content (input audio content) being very different from the reference audio content.

While the automatic stereo audio method can process input audio signals regardless of their level of similarity to the reference content the method is also capable of automatically processing input signals regardless of their level quality, e.g. the automatic processing method can be applied to both UGC and PGC.

In some implementations, determining an audio processing scheme to be applied in each frequency band comprises selecting a widening processing scheme or a tightening processing scheme. That is, the audio signal automatically widened or tightened to approach the stereo width of the reference audio content.

In some implementations, the method further comprises performing mid-side rebalance of the output audio signal, the mid-side rebalance comprising determining a mid and side ratio of the output audio signal, determining a mid-side ratio difference between the mid and side ratio of the output audio signal and a mid-side ratio of the target acoustic image metric and adjusting a mid and/or side audio signal of the output audio signal to reduce the mid-side ratio difference.

Accordingly, the mid-side balance of the stereo audio signal is adjusted to approach the reference audio signal in addition to, or as an alternative to, modification of the stereo width.

According to a second aspect of the invention there is provided an audio processing system, comprising a processor connected to a memory, wherein the processor is configured to perform the method of the first aspect of the invention.

### BRIEF DESCRIPTION OF THE DRAWINGS

Aspects of the present invention will be described in more detail with reference to the appended drawings, showing embodiments of the invention.

FIG. 1 is block-diagram depicting an audio processing system according to some implementations.

FIG. 2 is flow-chart describing a method for processing audio signals according to some implementations.

FIG. 3 is block-diagram showing a frame and band splitter according to some implementations.

FIG. 4 is block-diagram showing a pre-processing module according to some implementations.

FIG. 5 is block-diagram showing a tightening processing module according to some implementations.

FIG. 6 is block-diagram showing a widening processing module according to some implementations.

FIG. 7 is block-diagram showing a post-processing module according to some implementations.

FIG. 8 is graph illustrating schematically how an audio signal is divided into frames and frequency bands according to some implementations.

FIG. 9 is block-diagram showing a reference signal analyzer according to some implementations.

FIG. 10 is block-diagram showing a tuning module according to some implementations.

### DETAILED DESCRIPTION OF CURRENTLY PREFERRED EMBODIMENTS

Systems and methods disclosed in the present application may be implemented as software, firmware, hardware or a combination thereof. In a hardware implementation, the division of tasks does not necessarily correspond to the division into physical units; to the contrary, one physical component may have multiple functionalities, and one task may be carried out by several physical components in cooperation. The computer hardware may for example be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that computer hardware. Further, the present disclosure shall relate to any collection of computer hardware that individually or jointly execute instructions to perform any one or more of the concepts discussed herein.

Certain or all components may be implemented by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system (e.g., a computer hardware) that includes one or more processors. Each processor may include one or more of a CPU, a graphics processing unit, and a programmable DSP unit. The processing system further may include a memory subsystem including a hard drive, SSD, RAM and/or ROM. A bus subsystem may be included for communicating between the components. The software may reside in the memory subsystem and/or within the processor during execution thereof by the computer system.

The one or more processors may operate as a standalone device or may be connected, e.g., networked to other processor(s). Such a network may be built on various different network protocols, and may be the Internet, a Wide Area Network (WAN), a Local Area Network (LAN), or any combination thereof.

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

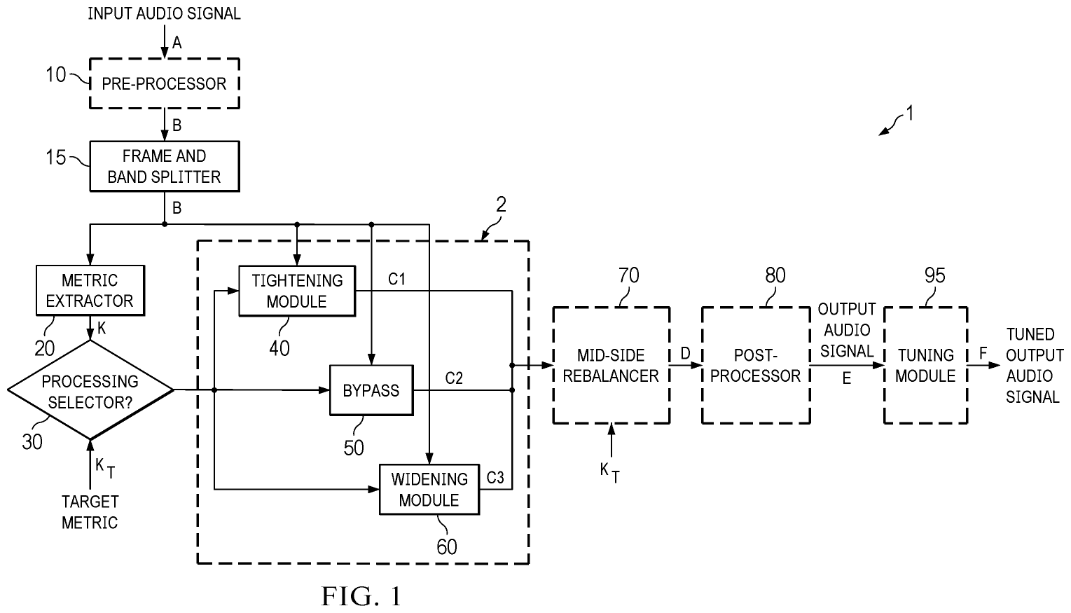

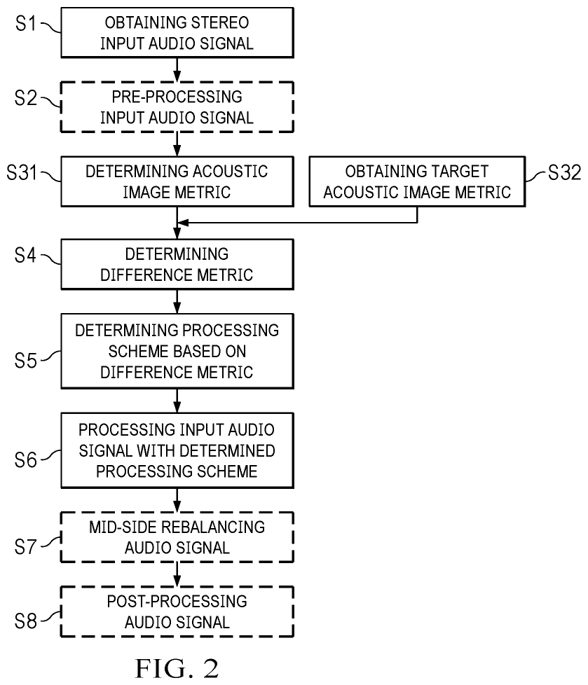

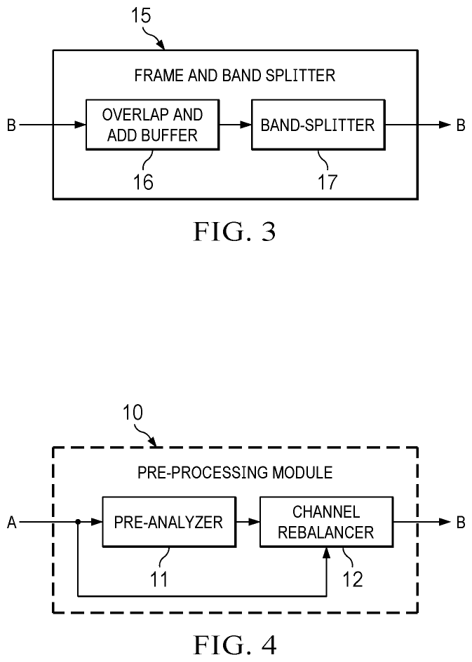

FIG. 1 is a block-diagram depicting an audio processing system 1 according to some implementations. The audio processing system 1 may be referred to as an automatic stereo mastering system. With further reference to FIG. 2, showing a flowchart for processing an audio signal, the operation of the audio processing system 1 will now be described in more detail. The audio processing system 1, and likewise the method for processing an audio signal, can operate either offline or online (e.g., in substantially real time). In offline processing, an entire audio signal file (e.g. an entire music track) is available and the whole audio signal file can be considered by any processing/analysis module or step. In online processing only a past and current portion of the audio signal is available, with the optional addition of a limited lookahead portion meaning mainly a current and past portion of the audio signal can be considered by any processing/analysis module or step. Offline processing is e.g. commonly used when mastering audio signals and online processing is commonly used in e.g. streaming scenarios or teleconferencing scenarios.

At step S1 the audio processing system 1 obtains an input audio signal A and, optionally, provides the input audio signal A to a pre-processing module 10. The pre-processing module 10 processes the input audio signal A at optional step S2 to obtain a preprocessed audio signal B. The pre-processing module 10 is optional and will be described in further detail below, in connection to FIG. 4. In implementations, where the pre-processing module 10 is not used the input audio signal A replaces the preprocessed audio signal B in the below.

The input audio signal A and the preprocessed audio signal B may both be stereo audio signals. A stereo audio signal comprises a pair of stereo signals or “channels” such as a left-right L, R pair of channels or a mid-side M, S pair of channels.

The input audio signal A may also be a mono audio signal comprising a single channel. In such implementations, the mono input audio signal A is first duplicated to form a stereo input audio signal which is provided to the pre-processing module 10.

The pre-processed audio signal B is provided to a frame and band splitting module 15 which splits the pre-processed audio signal B into a plurality of subsequent time-frames and frequency bands. That is, the pre-processed audio signal B is divided into a series of consecutive time frames that may be partially overlapping or wholly non-overlapping in time. For example, each time frame may contain 40 ms of the preprocessed audio signal B with a 50% overlap.

Each time frame of the pre-processed audio signal B is then split into a plurality of frequency bands. For example, each time frame is split into two or more frequency bands (e.g., three frequency bands). In some implementations, the time frames are split into three frequency bands, a low frequency band comprising frequencies below 120 Hz, a mid frequency band comprising frequencies between 120 Hz and 1500 Hz, and a high frequency band comprising frequencies above 1500 Hz.

The time framed and band split pre-processed audio signal B is provided to a metric extractor 20 and a stereo width processing block 2. The metric extractor 20 is configured to extract an acoustic image metric K of the preprocessed audio signal B, at step S31. The acoustic image metric K indicates at least one of a channel level difference and a correlation between the channels of the pre-processed audio signal B. For example, the metric extractor determines a power ratio of a mid and side channel representation of the pre-processed audio signal B and/or a cross-correlation between the channels of the pre-processed audio signal B, referred to as the inter-channel cross-correlation (ICC).

By dividing the pre-processed audio signal B into frames, and dividing each frame into frequency bands a time-frequency representation is formed comprising a plurality of “tiles” wherein each tile represents a frequency band of a frame of the preprocessed audio signal B. The metric extractor 20 may then determine the acoustic image metric for each frequency band of each frame individually, e.g. determine the ICC and/or mid-side power ratio (MIS-ratio) of the channels for each frequency band of each frame individually.

To determine the (MIS-ratio) the metric extractor 20 may, if necessary, first convert the channels of the pre-processed audio signal B to mid-side channels and then determine the power ratio between the channels. For example, it is envisaged that the pre-processed audio signal B comprises a left and right, L, R audio channel which are converted to a mid channel M and a side channel S. Conversion from left and right, L, R audio channels to mid and side M, S audio channel may e.g. be achieved using

$$M = \frac{L + R}{a} \qquad ( eq . 1 )$$

$$S = \frac{L - R}{a} \qquad ( eq . 2 )$$

wherein a is a constant with a=2 or a=\sqrt{2}.

The acoustic image metric K (comprising e.g. ICC and/or a MIS-ratio) is provided to a processing selector 30. The processing selector 30 also obtains at step S32 a target acoustic image metric K_{T} having a target image metric corresponding to the acoustic image metric K extracted from the preprocessed audio signal B. For example, the metric extractor 20 determines an ICC and/or MIS-ratio for each frequency band and frame and the processing selector 30 receives as the target acoustic image metric K_{T} target ICC and/or MIS-ratio for each frequency band and time frame, a single target ICC and/or MIS-ratio for all frequency bands and frames or a mean/median target ICC and/or MIS-ratio for each frequency band.

The target acoustic image metric K_{T} has been determined from a set of reference audio signals comprising a specific type of audio content, such as music, speech, the soundtrack of a movie etc. It is also envisaged that the specific type of audio content is a specific genre of music, such as rock, pop, classical, blues, country, jazz, electronic, hip-hop, rhythm and blues (R&B), metal or soul or a specific type of movie soundtrack, such as action, romantic or comedy. It also envisaged that the target acoustic image metric K_{T} is determined manually or that the target acoustic image metric K_{T} is determined from a set of reference audio signals and then manually modified by a user. For example, a user may select a target acoustic image metric associated with classical music, but tune the MIS-ratio or ICC of the target acoustic image metric in at least one frequency so as to achieve stereo width that is wider/narrower or more/less correlated in at least one frequency compared to what is indicated by the default target acoustic image metric K_{T}.

The determination of the acoustic image metric K and the thereon based determination of the processing scheme to be performed can be performed both offline and online. For example, in offline processing, the acoustic image metric K of each frame, and each frequency band of the frame, may be determined for a full audio signal file. In online processing, the full audio signal file will not be available and the metric extractor 20 may then determine an acoustic image metric that is continuously updated based on the portion of the audio signal contained in a buffer (containing e.g. a current frame and one or more previous frames and optionally one or more future, lookahead, frames) whereby the determination of the audio processing scheme is updated accordingly. At the initialization of online processing there will in some implementations be no, or only a very short, portion of the audio signal available. In such implementations the processing selector 30 specifies a default processing scheme until a sufficient portion of the audio signal has been obtained to start the extraction of an “informed” acoustic image metric K. For example, the default setting is to use the bypass route or perform widening processing with a predetermined amount of decorrelation. Once an “informed” acoustic image metric K is available the processing selector 30 will resume regular operation by determining an acoustic image metric difference and determine the processing scheme to be applied based on the difference.

In some implementations where some latency is acceptable, it is envisaged that the audio processing systems waits with processing until a predetermined amount of lookahead audio signal content has been obtained (e.g. 5 seconds of content) whereby the processing starts with determining the acoustic image metric K for the lookahead portion and then is updated continuously as the content in the buffer is replaced.

The processing selector 30 compares the target acoustic image metric K_{T} with the acoustic image metric of the metric extractor 20 and determines, based on the comparison, an acoustic image difference at step S4. Based on the acoustic image difference, a processing scheme to be applied in the stereo width processing block 2 is determined by the processing selector at step S5. For example, if the acoustic image metric K and the target acoustic image metric K_{T} includes a respective ICC the processing selector 30 may determine that the stereo width processing block 2 should apply a widening processing scheme if the ICC of the acoustic image metric K is above that of the ICC in the target acoustic image metric K_{T}. Accordingly, the stereo image of the pre-processed audio signal B will be widened so as to become perceptually more similar to the specific type of audio content in the set of reference audio signals.

In one implementation, the processing selector 30 receives as the target acoustic image metric K_{T} a target ICC and target MIS-ratio for each time frame frequency band and receives as the acoustic image metric K a detected ICC and detected MIS-ratio for each time frame and frequency band from the metric extractor 20. The processing selector 30 may then determine for each time frame and frequency band a difference between (i) a mean and median ICC and a mean and median MIS-ratio of the target acoustic image metric K_{T} and (ii) a mean and median ICC and a mean and median MIS-ratio of the acoustic image metric K the acoustic image metric K, respectively. Accordingly, for each time frame and frequency band four values, ICCₘₑₐₙ(b), ICC_{median}(b), MSₘₑₐₙ(b), MS_{median}(b) with b being the frequency bands, b=1, 2, 3, . . . are obtained from the pre-processed audio signal B and corresponding four values, ICC_{mean, target}(b), ICC_{median, target}(b), MS_{mean, target}(b), MS_{median, target}(b), are obtained from the target acoustic metric K_{T}.

The processing selector 30 determines that a frequency band and time frame be processed with the tightening processing scheme implemented by the tightening processor 40 at step S6 if it is determined that:

$$1.$$

$${ICC}_{mean} ( b ) < {ICC}_{mean \_ target} ( b ) ,$$

$$2.$$

$${ICC}_{median} ( b ) < {ICC}_{median , target} ( b ) , and$$

$$3.$$

$${MS}_{median} ( b ) < {MS}_{median , target} ( b ) .$$

On the other hand, processing selector 30 determines that a frequency band and time frame should be processed with a widening processing scheme implemented by the widening processing module 60 at step S6 if it is determined that:

$$1.$$

$${ICC}_{mean} ( b ) > {ICC}_{mean \_ target} ( b ) ,$$

$$2.$$

$${ICC}_{median} ( b ) > {ICC}_{median , target} ( b ) , and$$

$$3.$$

$${MS}_{median} ( b ) > {MS}_{median , target} ( b ) + slack ( b )$$

wherein slack(b) is a value in dB that can be selected individually for each band b. For example, slack (b) is about 2 dB.

If it is determined that the requirements for neither of tightening processing scheme or the widening processing scheme are fulfilled the processing selector determines that the stereo width processing block 2 should be bypassed by selecting the route 50 for the time frame and frequency band. The bypass route 50 merely passed the pre-processed audio signal B forward without modifying it. For example, it may be determined that the extracted acoustic image metric K, for one or more frequency bands and frames, is sufficiently close to the target acoustic image metric K_{T} such that no stereo width processing is performed.

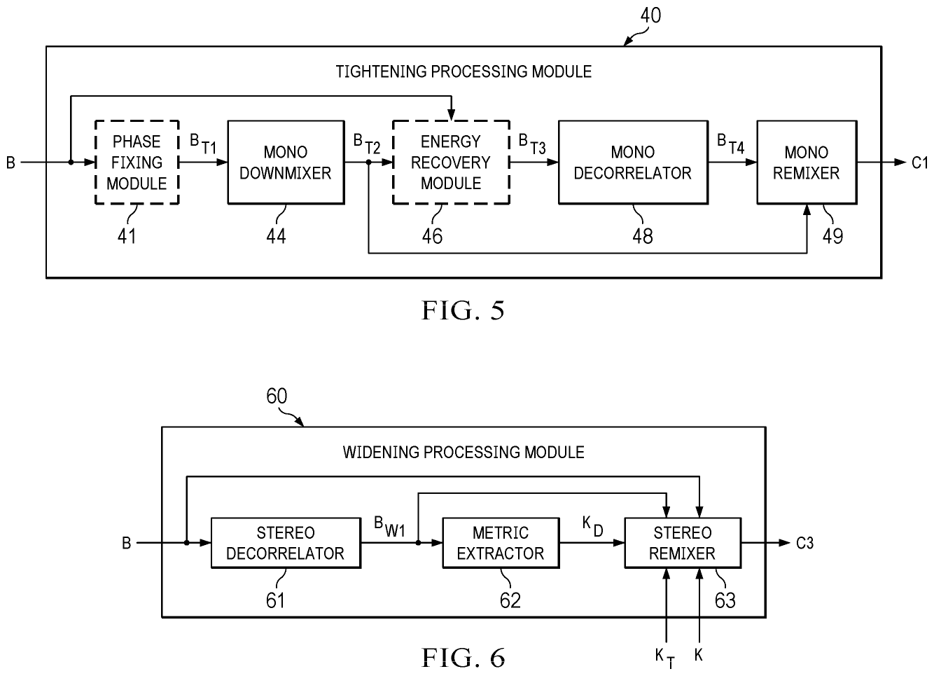

The tightening and widening processing modules 40, 60 are described in more detail in the below in connection to FIG. 5 and FIG. 6, respectively. In brief, the stereo image processing block 2 adjusts the stereo width (by tightening or widening processing) to approach an audio signal with acoustic image metrics more similar to those of the target acoustic image metric K_{T}. The output of the stereo width processing block 2 is thus for each audio frame and frequency band either a tightened audio signal C1, a bypass audio signal C2 or a widened audio signal C3 extracted from the pre-processed audio signal B. The output of the stereo width processing block 2 is optionally provided to a mid-side rebalancer 70. The audio signal C1, C2, C3 output by the stereo width processing block is sometimes referred to as a processed audio signal.

The optional mid-side rebalancer 70 takes the output C1, C2, C3 of the stereo width processing block 2 and performs at optional step S7 channel boosting and/or suppression to form a mid-side rebalanced audio signal D with a MIS-ratio that is equal to, or at least closer to, the target M/S-ratio of the target acoustic image metric K_{T}. As the MIS-ratio of the frames and frequency bands may have changed from the preprocessed audio signal B (due to processing with the stereo width processing block 2) the mid-side rebalancer 70 may be configured to determine at least the MIS-ratio for each frame and frequency band of the output signal C1, C2, C3 from the stereo width processing module 2 and use this MIS-ratio (referred to as the detected MIS-ratio) to determine a difference relative the MIS-ratio of the target acoustic image metric K_{T}. It is based on this difference the mid-side rebalancing processing of the mid-side rebalancer 70 is controlled. Accordingly, the mid-side rebalancer 70 may comprise an additional metric extractor, identical to the metric extractor 20 and configured to at least determine the MIS ratio for each time frame and frequency band of the output signal C1, C2, C3.

In one implementation, the mid-side rebalancer 70 determines for each frame and frequency band the difference between the target MIS-ratio of the target acoustic image metric K_{T} and the detected MIS-ratio, based on this difference, one of the mid and side audio channels is boosted or attenuated to reach the target mid-side ratio.

Alternatively, the difference is used to determine a distance in decibels between the target MIS-ratio and the detected MIS-ratio. By dividing this distance in decibels in half and boosting the weaker of the mid and side audio signal with half the decibel distance and attenuating the stronger of the mid and side audio signal with half the decibel distance the target MIS-ratio is achieved. For instance, the detected MIS-ratio may indicate that the mid channel is 10 dB stronger than the side channel whereas the target MIS-ratio indicates that the mid channel is 4 dB stronger than the side channel. The decibel distance is thus 10−4=6 dB whereby the mid audio signal is attenuated with 6/2=3 dB and the side audio signal is boosted with 3 dB to the reach the target MIS-ratio.

To avoid too rapid attenuation/boosting (which could be noticeable for a listener) a mean (e.g. root mean square) difference between target MIS-ratio and detected M/S-ratio may be determined across a plurality of frames in each frequency band and used to determine the attenuation/boosting. With mean difference values the mid-side rebalancing will be smoothed over time which may mitigate noticeable artifacts. In some offline implementations, the root mean square MIS-ratio difference is determined in each frequency band across all frames in an audio signal file whereby a same attenuation/boosting is applied for frames of a same frequency band in the audio signal file.

In some implementations, the mid-side rebalancer 70 obtains a tunable parameter as input wherein the tunable parameter comprises a user MIS-ratio that is to be used or a limiting range limiting the amount of boosting or attenuation that is applied by the mid-side rebalancer 70.

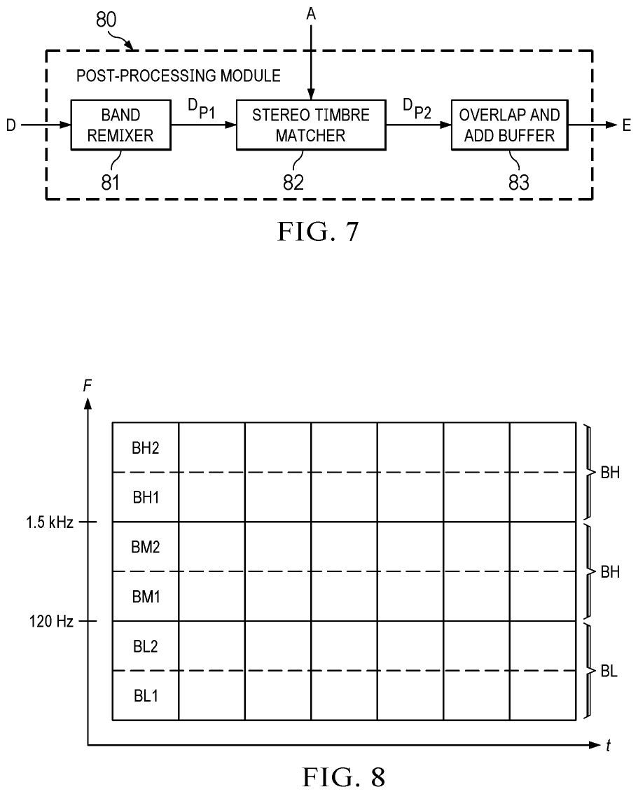

The mid-side rebalancer outputs a mid-side rebalanced audio signal D which is forwarded to an optional post-processing module 80 which performs post-processing at optional step S8 to obtain the output audio signal E. The post-processing module 80 may e.g. perform input energy matching and or timbre preservation, as will be described in further detail in connection to FIG. 7 below. It is understood that the mid-side rebalancer 70 and/or the post-processor 80 is optional and can be omitted for some implementations. In such implementations, the processed audio signal output by stereo width processing block 2 is provided directly as the output audio signal E, the mid-side rebalanced audio signal D is provided as the output audio signal E or the processed audio signal output by stereo width processing block 2 is provided to the post-processing module 80 directly.

The output audio signal E is optionally provided to a subsequent tuning module 95 which provides user control for adjusting the output audio signal E in an intuitive and capable manner. The tuning module 95 is described in further detail in connection to FIG. 10 below.

The pre-processor 10 is optional and may in some implementations be omitted entirely. In these implementations, the input audio signal A is provided directly to the frame and band splitter 15 and it is a frame and band split input audio signal A that is provided to the stereo width processing block 2 and metric extractor 20. Similarly, it is understood that mid-side rebalancer 70 and the post-processor 80 are also optional whereby the signal D output by the mid-side rebalancer 70 or signal C1, C2, C3 output by the stereo width processing block 2 can be provided as the final output signal of the audio processing system 1.

In some implementations, the band splitting function of the frame and band splitter 15 is omitted whereby the input audio signal or pre-processed audio signal is processed in full-band. In such implementations, the stereo width processing block 2 may be toggled between the three processing paths 40, 50, 60 for the full-band from one time frame to the next or one of the three processing paths 40, 50, 60 is selected for a full-band complete audio signal.

FIG. 4 is a block-diagram showing a pre-processor 10 according to some implementations. The pre-processor 10 obtains the input audio signal A and provides it to a pre-analyzer 11. The pre-analyzer 11 makes a simple full-band and full-file (e.g., offline) analysis of the input audio signal A. In some implementations, the pre-analyzer 11 determines the mean (e.g. the root mean squared, RMS) energy or power for a full frequency band covering all frequencies for each channel respectively. The mean energy or power of both channels is provided to the subsequent channel rebalancer 12 alongside the input audio signal A wherein the channel rebalancer 12 boost or attenuates one of the channels to balance the mean energy or power for the channels which forms a channel rebalanced audio signal A′. As an example, the mean power for a first channel (e.g. the left channel) is 2 dB higher compared to a second channel (e.g. the right channel), whereby the channel rebalancer 12 boosts the second (right) channel with 2 dB. In some implementations, the attenuation or boosting is limited to a range which may be tunable and adjusted by the user. The channel rebalancer 12 may also achieve channel balancing by remixing the channel associated with the higher mean power into the channel associated with the lower mean power. In some implementations, the channel rebalancer 12 both boosts the channel associated with a lower mean power and remixes the channel associated with the higher mean power into the channel associated with the lower mean power.

The pre-processing module 10 is optional as described in the above and in some implementations, e.g. for online processing, the pre-processing module 10 is omitted. Alternatively, the pre-processing module 10 is used for online processing and operates on buffered audio content with a moving averaging window for the channel energy levels.

In FIG. 5 a block-diagram describing a tightening processing module 40 applying a tightening processing scheme according to some implementations is shown. The tightening processing module 40 is one of the three alternative processing modules of the stereo width processing block 2 shown in FIG. 1, besides the bypass route 50 and the widening processing module 60.

The tightening processing module 40 obtains the pre-processed audio signal B and performs phase fixing with a phase fixing module 41. The phase fixing module 41 determines, for each frequency band and frame the correlation level between the channels of the pre-processed audio signal B. Optionally, the phase fixing module 41 also smooths the correlation over time using e.g. classic recursive filtering with predetermined attack and decay time constants, to obtain a smoothed correlation level. For each frame and frequency band, the phase fixing module 41 determines if the (optionally smoothed) correlation level is below a predetermined threshold level. If the (smoothed) correlation level is below the predetermined phase fixing threshold level a predetermined channel of the pre-processed audio signal B is inverted for the specific frame and frequency band, otherwise none of the channels is inverted. For example, the predetermined phase fixing threshold level is about 0.2 or about 0.5. In some implementations, the phase fixing threshold can be tuned by the user.

In some implementations, determining whether to invert the predetermined channel is taken per band for a plurality of frames, such as for all frames of an audio signal file (offline processing) or for past frames and/or all frames present in the buffer (online processing). In an example implementation of online processing, the phase fixing module 41 determines if the (optionally smoothed) correlation level has been below the predetermined threshold consistently for a number of past frames. If this is the case the phase fixing module 41 inverts one channel for future frames. To achieve this, the mean correlation level for a plurality of frames of a frequency band is determined and if the mean is below the predetermined phase fixing threshold value, the predetermined channel is inverted for all frames in the plurality of frames.

Additionally, to avoid letting quiet and loud frames influence the mean correlation level for a plurality of frames to the same extent, a weighting factor proportional to the energy level of each frame and frequency band may be applied to the corresponding correlation level. In this way, more quiet frames (e.g., lower energy/power frames) will not influence the phase inversion decision as much as more loud frames (e.g., higher energy/power frames).

Another alternative method for achieving a quiet and loud frame weighting is determining a percentile of the loudest frames in the plurality of frames (e.g. the loudest 30% of the frames) and determining the mean correlation level for this percentile of the frames instead of for all frames in the plurality of frames.

The phase-fixed audio signal B_{T1} output by the phase fixing module 41 (having potentially one channel phase inversed w.r.t. the pre-processed audio signal B) is provided to a subsequent mono downmixer 44. The mono downmixer 44 downmixes the phase-fixed audio signal B_{T1} output by the phase fixing module 41 to a phase-fixed mono downmix audio signal B_{T2}. In some implementations, the phase-fixed audio signal B_{T1} comprises a left and right channel whereby the mono downmixer applies equation 1 in the above and determines a mid channel, which is used as phase-fixed mono downmix audio signal B_{T2}. The phase-fixed mono downmix audio signal B_{T2} is then provided the subsequent energy recovery module 46.

The energy recovery module 46 determines a first set of energy or power levels for each frame and frequency band of the pre-processed (stereo) audio signal B by averaging the energy or power for both channels in the pre-processed audio signal B. Similarly, the energy recovery module 46 determines second set of energy or power levels for each frame and frequency band of the phase-fixed mono downmix audio signal B_{T2} determined by the preceding mono downmixer 44. The energy recover module 46 may operate both offline (e.g. process an entire audio signal file) and online (e.g. continuously process the audio signal portion contained in the buffer).

Optionally, the energy recovery module 46 smooths the energy or power level of each set, respectively, across time for each frequency band, e.g. with classic recursive filtering with predetermined attack and decay time constants, to obtained smoothed first and second sets of energy or power levels for the pre-processed audio signal B and phase-fixed mono downmix audio signal B_{T2} respectively.

The energy recovery module 46 is further configured to determine for each frequency band a set of differences in energy or power level between each element in the first and second (optionally smoothed) sets of energy or power levels. It is envisaged that the set of differences in energy or power level could optionally be smoothed over time (e.g., across multiple consecutive frames) and/or frequency (e.g., across multiple consecutive frequency bands).

The (optionally) smoothed set of differences in energy or power level is used by the energy recovery module 46 to determine a gain for each frame and frequency band to be applied to the phase-fixed mono downmix audio signal B_{T2} to match the energy or power level of the pre-processed audio signal B. The determined gains then applied to the phase-fixed mono downmix audio signal B_{T2} to obtain an energy preserved downmix mono audio signal B_{T3} which is output by the energy recovery module 46.

Optionally, to avoid excessive gain adjustments the determined gain is limited to a predetermined range of gains prior to being applied to the downmix mono audio signal. In some implementations, the predetermined range of gains is between −10 dB and 10 dB. With this range a gain being between −10 dB and 10 dB is maintained whereas gains below −10 dB are set to −10 dB and gains above 10 dB are set to 10 dB.

The energy preserved downmix mono audio signal B_{T3} is provided to a mono decorrelator 48 which processes the energy preserved downmix mono audio signal B_{T3} to obtain a decorrelated mono audio signal B_{T4}.

In some implementations, the mono decorrelator 48 comprises a filter that given an input mono audio signal B_{T3} produces an output mono audio signal B_{T4} with a different phase. The decorrelation is maximum when the phase difference between B_{T3} and B_{T4} is 90°±N*180, wherein N is an integer. The filter is an all-pass filter in order to change the phase while leaving the amplitude mostly untouched. While a single all-pass filter is sufficient in some implementations of the mono decorrelator 48, other implementations utilize a mono decorrelator 48 with at least two all-pass filters combined, for better control of the phase shift over the whole bandwidth of interest. Furthermore, since all-pass filters risk causing a smearing of the audio transients, the mono decorrelator 48 may further comprise a transient detection mechanism to control the amount of decorrelation (e.g., the introduced phase-shift) accordingly. For example, the controlling may comprise mixing the input signal B_{T3} with the all-passed signal B_{T4} in a time-dependent way, wherein if a transient is detected the input signal B_{T3} is retained, and if no transient is detected the all-passed signal B_{T4} is retained. This is for example described in more detail in “SYSTEM AND METHOD FOR REDUCING TEMPORAL ARTIFACTS FOR TRANSIENT SIGNALS IN A DECORRELATOR CIRCUIT” filed as a PCT application and published as WO/2015/017223, hereby incorporated by reference in its entirety.

The decorrelated mono audio signal B_{T4} is provided to a mono remixer 49 alongside the phase-fixed mono downmix audio signal B_{T2}. The mono remixer 49 is configured to mix the decorrelated mono audio signal B_{T4} with the phase-fixed mono downmix audio signal B_{T2} to form the tightened stereo audio signal C1. In some implementations, the mono remixer 49 combines the respective frequency bands of audio signals B_{T2}, B_{T4} into full frequency bands, whereby the remixing is performed in a single full band. The tightened stereo audio signal C1 comprises a left channel C1_{L} and a right channel C1_{R} whereby the left and right channels C1_{L}, C1_{R} are obtained by the mono remixer as

$$C {1}_{L} = ( 1 - g ) \times {B}_{T 2} + g \times {B}_{T 4} \qquad ( eq . 3 )$$

$$C {1}_{R} = ( 1 - g ) \times {B}_{T 2} - g \times {B}_{T 4} \qquad ( eq . 4 )$$

wherein g is a gain between zero and one.

The mono remixing results in tightened version of the pre-processed audio signal B as the tightening processing is triggered when the pre-processed audio signal is associated with a too wide stereo width (e.g. too low ICC).

In some implementations, the phase-fixing module 41, mono downmixer 44 and energy recovery module 46 may operate at finer granularity frequency bands compared to the other parts of audio processing system 1, such as the frequency granularity at which the acoustic image metric K is determined. To this end, the phase fixing module 41 may be preceded by a fine granularity band splitting module which splits the pre-processed audio signal B into a plurality of fine granularity frequency bands (e.g. six, eight or more bands) whereby the energy recovery module 46 is succeeded by an fine granularity band combiner which recombines the fine granularity frequency bands into an original set of (comparatively more coarse) frequency bands (e.g. full-band or three bands).

FIG. 6 shows a block-diagram of a widening processing module 60 according to some implementations. With further reference to FIG. 1, the pre-processed audio signal B is provided to one of three processing modules 40, 50, 60 of the stereo width processing block 2 wherein the widening processing module 60 is one of the three processing modules used to widen the stereo width of pre-processed audio signal B when the this audio signal is determined by the processing selector 30 to be too narrow by comparison to the target acoustic image metric K_{T} (e.g. due to a too high ICC).

In the widening processing module 60 the (stereo) pre-processed audio signal B is provided to a stereo decorrelator 61 which processes the pre-processed audio signal B to obtain a decorrelated stereo audio signal B_{W1}. In most practical implementations, the pre-processed audio signal B will already feature some level of decorrelation. That is, the cross-correlation is <1. However, in comparison to the target acoustic image metric K_{T} the pre-processed audio signal still exhibits a too high correlation meaning that widening processing is to be implemented to approach the specific type of audio content.

The stereo decorrelator 61 is configured to obtain a decorrelated stereo audio signal B_{W1} that has lower correlation compared the pre-processed audio signal B. To achieve this, the stereo decorrelator 61 according to one implementation comprises two mono decorrelators, wherein one decorrelator is used to process each channel of the pre-processed audio signal B. Each mono decorrelator may e.g. be equivalent in operation to the mono decorrelator 48 used in the tightening processing module 40 as shown in FIG. 5, however the two mono decorrelators are individual and configured to implement decorrelation processing (e.g. different phase shifts) such that the resulting decorrelated mono audio signals are decorrelated with respect to each other.

As an example, the pre-processed audio signal B has two channels labeled B_{L} and B_{R} (for example, B_{L} is a left channel and B_{R} is a right channel) and the decorrelated stereo audio signal B_{W1} comprises two channels labeled B_{W1,L} and B_{W1,R} (for example, B_{W1,L} is a left channel and B_{W1,R} is a right channel). The stereo decorrelator 61 is configured to ensure that corr(B_{W1,L}, B_{W1,R})<corr(B_{L}, B_{R}) wherein corr(α, β) denotes the cross-correlation level between the arguments α and β. By processing each channel B_{L}, B_{R} of the pre-processed audio signal B with a separate decorrelator it is established that corr(B_{W1,L}, B_{L})<1 and that corr(B_{W1,R}, B_{R})<1 which in turn means that corr(B_{W1,L}, B_{W1,R})<corr(B_{L}, B_{R}).

The decorrelated stereo audio signal B_{W1} output by the stereo decorrelator 61 is provided to a metric extractor 62 which determines an acoustic image metric K_{D} for the decorrelated stereo audio signal B_{W1}. The acoustic image metric K_{D} comprises at least the median ICC for the channels of the decorrelated stereo audio signal B_{W1} (which will be lower compared to the median ICC for the channels of the pre-processed audio signal B due to processing with the stereo decorrelator 61). The metric extractor 62 may be equivalent to the metric extractor 20 described in connection to FIG. 1 in the above and operate in online and offline modes.

The decorrelated stereo audio signal B_{W1} is provided to a stereo remixer 63 alongside the pre-processed audio signal B and the acoustic image metric K_{D} associated with decorrelated stereo audio signal B_{W1}. The stereo remixer 63 also obtains the target acoustic image metric K_{T} and the acoustic image metric K of the pre-processed audio signal B. The stereo remixer 63 performs channel-wise mixing of the pre-processed audio signal B with the decorrelated stereo audio signal B_{W1} at a mixing ratio g_{dry}, wherein 0≤g_{dry}≤1, the proportion of the pre-processed audio signal B is g_{dry} and the proportion of the decorrelated stereo audio signal B_{W1} is (1−g_{dry}). The resulting output of the stereo remixer 63 is a widened stereo audio signal C3.

The mixing ratio g_{dry} is set to obtain a widened stereo audio signal C3 with a median ICC equal to, or at least closer to, the target median ICC (referred to as ICC_{Target}) dictated by the target acoustic image metric K_{T}. In one implementation, g_{dry} is determined by interpolating using the target median ICC between two values, a first value being the median ICC of the pre-processed audio signal (referred to as ICC_{B}) which is some non-zero value <1 and a second value being the median ICC of the decorrelated stereo audio signal (referred to as ICC_{BW1}). That is, a value of g_{dry} should be identified which fulfills

$${ICC}_{T a rget} = {g}_{dry} \times {ICC}_{B} + ( 1 - {g}_{dry} ) {ICC}_{BW 1} \qquad ( eq . 5 )$$

wherein the mixing ratio g_{dry} is found as

$${g}_{dry} = \frac{{ICC}_{Target} - {ICC}_{BW 1}}{{ICC}_{B} - {ICC}_{BW 1}} \qquad ( eq . 6 )$$

This determination of g_{dry} is based on the assumption that intermediate values of the median ICC, between the median ICC of the pre-processed audio signal B, ICC_{B}, and the median ICC of the decorrelated stereo audio signal B_{W1}, ICC_{BW1} can be obtained by linear combination (e.g. mixing) of the pre-processed audio signal B with the decorrelated stereo audio signal B_{W1}.

It is envisaged that the mixing ratio g_{dry} may be replaced with a modified mixing ration g′_{dry} wherein the modified mixing ratio is the mixing ratio g_{dry} with a scaling factor:

$${g}_{dry} = {S}_{factor} \times {g}_{dry} \qquad ( eq . 7 )$$

wherein the scaling factor S_{factor} is tunable and e.g. determined by a user. A scaling factor of S_{factor}<1 means less correlation in the widened stereo audio signal C3 (giving an even wider stereo width) whereas a scaling factor of S_{factor}>1 gives more correlation in the widened stereo audio signal C3 (giving a narrower stereo width).

FIG. 7 depicts a block-diagram of post-processing module 80 according to some implementations. As described in connection to FIG. 1, the output signal D of the mid-side rebalancer 70 is provided as the input to the post-processing module 80. The band remixer 81 of the post-processing module 80 combines the resulting mid-side rebalanced audio signal D obtained for each frequency band into a single, full-band, audio signal Dpi. In some implementations, a single stereo width processing scheme is selected for each frequency band for the full audio file in the stereo width processing block 2. The selected stereo width processing scheme may be different from one frequency band to another frequency band. As an example, the pre-processed audio signal is divided into three frequency bands, a low-band, a mid-band and a high-band whereby for the low band and mid band stereo widening processing is selected as the stereo width is too narrow in these frequency band compared to the target acoustic image metric K_{T}, and the stereo tightening processing is selected for the high frequency band as the stereo width in this frequency band is to large compared to the target acoustic image metric K_{T}.

The full-band combined stereo audio signal Dpi generated by the band remixer 81 is then provided to a stereo timbre matcher 82 alongside the input audio signal A of the stereo processing system 1. The function performed by the timbre matcher 82 is making sure that the spectral envelope of full-band audio signal Dpi is identical, or at least similar, to that of the input audio signal A. The processing performed by the stereo timbre matcher 82 is similar to the processing performed by the energy recovery module 46 described in connection to FIG. 5 with the main difference being that the stereo timbre matcher 82 operates on stereo audio signal whereas the energy recovery module operates on mono audio signals. As for the energy recovery module, the timbre matcher 82 can operate in both online and offline mode, wherein in online mode the content present in the buffer is considered and in offline mode the full audio signal can be considered.

The stereo timbre matcher 82 obtains the full-band audio signal Dpi from the band remixer 81 as well as the input audio signal A of the stereo processing system 1. The stereo timbre matcher 82 determines for each audio signal the energy level for each channel and frequency band. That is, for each channel, frequency band and time frame the timbre matcher 82 determines an energy level for the input audio signal A and likewise for the full-band audio signal Dpi. Optionally, the stereo timbre matcher 82 smooths the energy levels over time (e.g. by means of convolution with a smoothing kernel across the frames). The stereo timbre matcher 82 determines, for each audio signal and frequency band, an average energy level of the at least two channels in each audio signal based on the determined (optionally smoothed) energy level.

An average energy level is thus obtained for each audio signal, frequency band and time frame. The stereo timbre matcher 82 determines an energy level difference (e.g. expressed in dB) between the input audio signal A and the full-band audio signal DP1. The energy level difference of each frequency band and time frame is used as timbre gain and, optionally, the determined timbre gain is smoothed across time and/or frequency (e.g. using a smoothing kernel extending in the time and/or frequency dimension).

Optionally, the (smoothed) timbre gains are also limited to a timbre gain range to avoid excessive suppression or boosting of the audio signals which could cause noticeable acoustic artifacts. The timbre gain range is e.g. from −10 dB to 10 dB or from −6 dB to 6 dB and may be tuned by a user.

The (optionally smoothed and/or limited) timbre gains are then applied to the corresponding time frames and frequency bands of the o full-band audio signal Dpi to form a frame and frequency band divided output audio signal D_{P2}. The frame and frequency band divided output audio signal D_{P2} is provided to an output overlap and add buffer 83 which combines the time frames and frequency bands into a single full-band audio signal which is provided as the output audio signal E of the audio processing system.

As for the phase mixing module 41, mono downmixer 44 and energy recovery module 46 discussed in connection to FIG. 5, the stereo timbre matcher 82 may also benefit from operating at finer granularity frequency bands compared to e.g. the frequency bands used by the stereo width processing block 2. In such implementations, the stereo timbre matcher 82 may be configured to first perform a band splitting process, splitting the frequency bands of the band remixer 81 into a plurality of fine granularity frequency bands, and perform the above mentioned processing in these fine granularity frequency bands, and finally recombine the frequency bands into the frequency bands used by the band remixer 81.

Dividing a full-band audio signal into one or more frequency bands or dividing an already banded audio signal into finer granularity frequency bands may be achieved with different methods. For example, complementary shelving filters, band-pass filters, filters in the frequency domain (e.g. FFT-filters) or QMF-filterbanks could be used. It is desirable that the filters are designed so that they ensure good reconstruction in the areas where adjacent bands overlap. For example, in the FFT domain overlapping filters (e.g. bell-shaped) filters that sum to unity in the overlapping region could be used. As another example, triangular filters could be used in the FFT domain with 50% overlap, wherein a subsequent triangular filter starts ramping up linearly at the center of a current triangular filter and the current filter ramps down linearly to zero where the subsequent band has its peak.

In the above, the band remixer 81 combines the frequency bands to allow full-band processing in the stereo timbre matcher 82. In some implementations, also the mid-side rebalancer 70 from FIG. 1 operates on a full-band representation meaning that the band remixer 81 also could be placed up-stream of the mid-side rebalancer 70, allowing both the mid-side rebalancer 70 and the stereo timbre matcher 82 of the post-processing module 80 to operate on full band representations.

With reference to FIG. 8 a graph showing schematically how an audio signal is divided into a plurality of frequency bands is shown. The time t is indicated along the horizontal axis and the frequency F is indicated along the vertical axis. The boxes BL1, BL2, BM1, BM2, BH1, BH2 indicate individual frequency bands of a channel of an audio signal in a specific time frame. The boxes to the right of the boxes BL1, BL2, BM1, BM2, BH1, BH2 indicate the next time frame, and the boxes to right of these boxes indicates the second next time frame and so on. Different components of the audio processing system 1 shown in FIG. 1 may operate on different granularity levels (e.g., resolution levels) in time and/or frequency. For instance, the pre-processor 10 will in some implementations operate on a single full-band representation of the input audio signal (e.g., all bands BL1, BL2, BM1, BM2, BH1, BH2 are combined into a single band) whereas the stereo width processing block operates on the audio signal divided into two or more (e.g. three) frequency bands. In some implementations, the stereo width processing block 2 operates using a high frequency band BH (comprising frequencies exceeding 1500 Hz), a mid frequency band BM (comprising frequencies between 120 Hz and 1500 Hz) and a low frequency band containing frequencies below 120 Hz although this selection of frequency bands is merely exemplary.

Additionally, some processing modules may benefit from operating using finer frequency granularity (e.g., higher frequency resolution and more frequency bands). To this end, the high, mid and low frequency bands may be sub-divided into smaller frequency bands as shown in FIG. 8 with the high frequency band BH comprising two sub-bands, BH1 and BH2 which both cover a narrower frequency range compared to the full high frequency band BH. Processing modules which may benefit from operating on finer granularity frequency bands is at least one of the stereo timbre matcher 82 (described in connection to FIG. 6), the phase fixing module 41, the mono downmixer 44, and the energy recovery module 46 (described in connection to FIG. 5). For example, these modules may operate using six, or eight or more frequency bands whereas the stereo width processing selector 30 which determines if a band is to be widened or narrowed operates using three frequency bands.

Switching from one time and/or frequency resolution to another can be achieved with anyone of a large number of methods which as such are known in the art. For example, a full-band audio signal can be reconstruction from a first time and/or frequency resolution whereby the full-band audio signal is used to construct an audio signal representation with a second, different, time and/or frequency resolution.

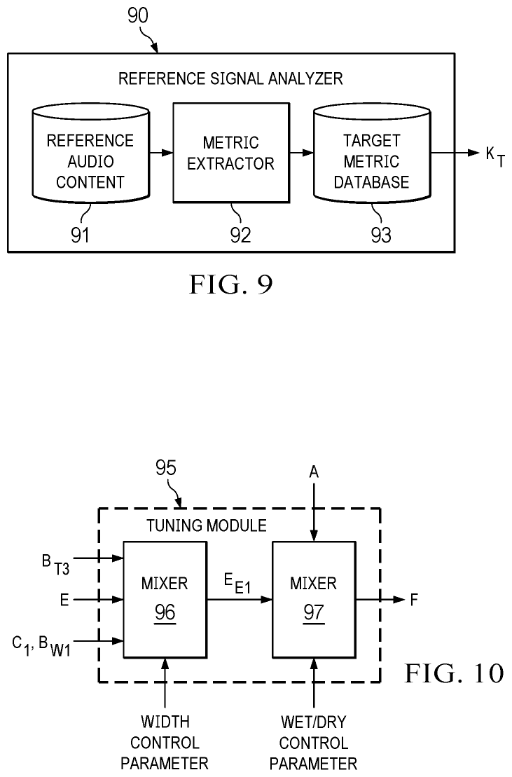

FIG. 9 shows a block diagram illustrating a reference signal analyzer 90 configured to determine a set of target acoustic image metrics K_{T}. The reference signal analyzer comprises an acoustic image metric extractor 92 configured to extract an acoustic image metric from a stereo audio signal. The acoustic image metric extractor may e.g. be identical to the metric extractor 20 described in connection to FIG. 1 above. A reference stereo audio signal is provided to the acoustic image metric extractor 92 from a database 91 containing reference audio content of a specific type. The acoustic image extractor 92 then determines an acoustic image metric from the reference audio content and stores it in the target acoustic metric database 93. For example, the acoustic image metric extractor 92 divides each audio channel of a reference stereo audio signal from the reference audio content into a plurality of frequency bands and time frames and determines, for each time frame and frequency band, one or more acoustic image metrics for the reference stereo audio signal. For example, the acoustic metric extractor 92 determines the ICC and the MIS-ratio for each time frame and frequency band of a reference stereo audio signal and subsequently calculates the mean and median ICC and mean and median MIS-ratio for the reference stereo audio signal.

In some implementations, the reference audio content comprises at least two reference stereo audio signals (e.g. two different music tracks of the same genre or two different movie soundtracks) and the acoustic image metric extractor 93 determines the mean and median ICC and mean and median MS-ratio (in dB) across all of said at least two stereo audio signals. In this way, a type-specific target acoustic image metric K_{T} can be obtained indicating the average acoustic image metric across a plurality of reference stereo audio signals of the specific type. This type-specific acoustic image metric may be provided as the target acoustic image metric M_{T} to the audio processing system 1 shown in FIG. 1.

The specific type of audio content may e.g. be one of music, speech or the soundtrack of a movie. The specific type of audio content may e.g. be a specific genre of music, for example rock, pop, classical, blues, country, jazz, electronic, hip-hop, rhythm and blues (R&B), metal or soul. It is also envisaged that the target metric database 93 may store target acoustic image metrics associated with different specific audio content types at the same time and a most suitable acoustic image metric is selected by the audio processing system 1 automatically or based on input by a user (e.g. indicating a desire to mimic the acoustic image properties of metal music).

As an example of automatic target acoustic image metric selection the audio processing system 1 from FIG. 1 may comprise an audio type classifier. The audio type classifier could e.g. be configured to perform spectral analysis and/or analysis of metadata to predict the type of audio content comprised in the audio signal to be processed. For example, the classifier predicts that the input audio signal comprises classical music. The audio processing system 1 may then automatically select the target acoustic image metric corresponding to this type of audio content. In accordance with the above example, the audio processing system will then select the target acoustic image metric associated K_{T} with classical music. It is also envisaged that the classifier could be realized using a neural network trained to predict the type of audio content comprised in the input audio signal A.

FIG. 10 shows block-diagram describing a tuning module 95 that can be used to fine tune the output audio signal E obtained from the audio processing system 1 shown in FIG. 1. The output audio signal E is already processed so as to feature acoustic image properties similar or identical to the acoustic image properties of the specific type of reference audio content. Accordingly, the output audio signal E can be used directly (e.g. transmitted, stored in a storage medium or played back).

In some implementations, the user may desire to further fine tune the output audio signal E and the fine tuning module in FIG. 11 provides this type of fine tuning. The output audio signal E is provided to a first mixer 96 of the tuning module 95 which mixes the output audio signal E with at least one of the phase-fixed energy preserved mono downmix audio signal B_{T3} from the tightening processing and the decorrelated stereo audio signal B_{W1} from the widening processing module. As an alternative to the decorrelated stereo audio signal B_{W1} from the widening processing module, a fully decorrelated stereo audio signal can be acquired from the mono remixer in the tightening processing module and used instead of the decorrelated stereo audio signal B_{W1}. This may be achieved by setting g=1 in equations 3 and 4 above whereby two audio signals are obtained, C1L and C1R, that are equal but with different signs.

The user may set a width control parameter indicating whether the output audio signal E should be widened or tightened. If the output audio signal is to be tightened, more of the phase-fixed energy preserved mono downmix audio signal B_{T3} is introduced into the mix and if the output audio signal is to be widened, more of at least one of the decorrelated stereo audio signals B_{W1}, C1 is introduced into the mix. The remixing could be done in full-band or in multiple sub-bands. For example, the user may specify whether the width-adjusting mixing of the mixer 96 is to be done full-band or independently in multiple frequency bands. If the latter example is selected, the user may specify each frequency individually, if and to what extent the frequency band should be widened or tightened. The resulting audio signal output by the mixer 96 is referred to as an enhanced output audio signal E_{E1}.

The enhanced output audio signal E_{E1} is provided to a second mixer 97 which mixes the enhanced output audio signal with E_{E1} with the input audio signal A to obtain a tuned output audio signal F. For example, remixing the input audio signal A may ensure that some desired acoustic properties lost or distorted in the processing are reintroduced into the tuned output audio signal F. The mixing ratio of the second mixer is governed by a wet/dry control parameter controlling the wetness or dryness of the tuned output audio signal F. An audio signal is referred to as “dry” if it consists mainly or wholly of a processed audio content and “wet” if it consists mainly or wholly of an unprocessed, raw, audio content. Accordingly, by controlling the wet/dry control parameter, which adjusts the mixing ratio of the second mixer 97 the wetness/dryness of the tuned output audio signal F can be adjusted.

As for the first mixer 96, it is envisaged that the second mixer can operate in full-band or independently for multiple frequency bands, with the user in the latter case being able to specify individual wet/dry control parameters for each frequency band in the latter case.

Unless specifically stated otherwise, as apparent from the following discussions, it is appreciated that throughout the disclosure discussions utilizing terms such as “processing”, “computing”, “calculating”, “determining”, “analyzing” or the like, refer to the action and/or processes of a computer hardware or computing system, or similar electronic computing devices, that manipulate and/or transform data represented as physical, such as electronic, quantities into other data similarly represented as physical quantities.

It should be appreciated that in the above description of exemplary embodiments of the invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention. Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with instructions for carrying out such a method or element of a method forms a means for carrying out the method or element of a method. Note that when the method includes several elements, e.g., several steps, no ordering of such elements is implied, unless specifically stated. Furthermore, an element described herein of an apparatus embodiment is an example of a means for carrying out the function performed by the element for the purpose of carrying out the embodiments of the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

The person skilled in the art realizes that the present invention by no means is limited to the embodiments described above. On the contrary, many modifications and variations are possible within the scope of the appended claims. For example, the division of the audio signal into different frequency bands as described in the above can be done in many different ways, and the skilled person understands that fewer or more frequency bands can be used with the same processing techniques. It is also noted that the audio processing system is suitable for many different specific types of audio content, such as speech or music and that the system may be configured to process audio signals both offline (allowing for e.g. a full audio file to be analyzed) and online (in substantially real-time with a limited amount of look-ahead).

1. An audio processing method comprising:
obtaining a stereo input audio signal comprising a specific type of audio content;
determining, from at least one frequency band of the input audio signal, at least one acoustic image metric of the input audio signal, the at least one acoustic image metric indicating a channel level difference or correlation between the two channels of the input audio signal in the at least one frequency band;
obtaining, for each frequency band, a target acoustic image metric, the target acoustic metric being determined from a set of reference stereo audio signals, each reference audio signal comprising the specific type of audio content;
determining, for each frequency band, a difference metric based on a difference between the acoustic image metric and the target acoustic image metric;
determining, for each frequency band and based on said difference metric, an audio processing scheme to be applied to decrease the difference metric; and
processing, each frequency band of the input audio signal with the audio processing scheme to obtain a processed audio signal.

2. The method of claim 1, wherein the acoustic image metric and the target acoustic image metric, respectively, comprises at least one of:
a power ratio of a mid and side channel, and
an inter-channel cross correlation, ICC, measure.

3. The method of claim 1, wherein determining an audio processing scheme to be applied in each frequency band comprises selecting a widening processing scheme or a tightening processing scheme.

4. The method of claim 1, wherein the acoustic image metric and the target acoustic image metric comprises a mid and side channel power ratio and an ICC measure,
wherein if the mid and side channel power ratio and the ICC measure, respectively, of the acoustic image metric in the at least one frequency band is lower compared to the target acoustic image metric a tightening audio processing scheme is applied in the at least one frequency band,
if the mid and side channel power ratio and the ICC measure, respectively, of the acoustic image metric is higher compared to the target acoustic image metric a widening audio processing scheme is applied in the at least one frequency band, and
else, the input audio signal is used as the processed audio signal in the at least one frequency band.

5. The method according to claim 3, wherein the tightening audio processing scheme comprises:
generating for the at least one frequency band a mono downmix audio signal based on the input audio signal;
processing the mono downmix audio signal with a decorrelator to obtain a decorrelated mono downmix audio signal;
forming a first channel of the processed audio signal based a weighted sum of the mono downmix audio signal and decorrelated mono downmix audio signal; and
forming a second channel of the processed audio signal based on a weighted difference of the mono downmix audio signal and the decorrelated mono downmix audio signal.

6. The method according to claim 5, further comprising phase fixing the input audio signal, the phase fixing comprising:
determining, for each of the at least one frequency band, an ICC measure of the two channels of the input audio signal; and
if said ICC measure is below a predetermined threshold, inverting one of the two channels of the input audio signal for the at least one frequency band.

7. The method according to claim 5, further comprising energy matching the downmix audio signal to the input audio signal, the energy matching comprising:
determining a spectral energy level in each of the at least one frequency band of the input audio signal;
determining a spectral energy level in each of the at least one frequency band of the mono downmix audio signal;
determining a difference in spectral energy level between the input audio signal and the mono downmix audio signal for each at least one frequency band; and
applying an energy matching gain to each frequency band the mono downmix audio signal, the energy matching gain being based on the difference in spectral energy level so as to reduce the difference in spectral energy level when the gain is applied to the mono downmix audio signal.

8. The method according to claim 7, wherein the input audio signal and the downmix audio signal comprises a set of consecutive frames, the method further comprising:
a combination of one more of, smoothing the spectral energy level, smoothing the difference in spectral energy level, and smoothing the energy matching gain over a plurality of frames.

9. The method according to claim 4, wherein the widening audio processing scheme comprises
processing the at least one frequency band of each channel of the input audio signal with a decorrelator respectively, to form a decorrelated stereo audio signal; and
mixing the at least one frequency band of the decorrelated stereo audio signal with the input audio signal at a mixing ratio to obtain the processed audio signal.

10. The method according to claim 9, further comprising
determining an ICC measure for the at least one frequency band of the channels of the decorrelated stereo audio signal; and
determining the mixing ratio by interpolating between the ICC measure of the input audio signal and the ICC measure of the decorrelated audio using the ICC measure of the target acoustic scene metric.

11. The method according to claim 10, wherein the mixing ratio is based on a ratio between a first difference and a second difference;
wherein the first difference is the difference between an ICC measure of the target acoustic image metric and the ICC measure of the decorrelated audio signal, and
wherein the second difference is the difference between the ICC metric of the acoustic image metric of the input audio signal and the ICC metric of the decorrelated audio signal.

12. The method according claim 1, further comprising performing mid-side rebalancing of the processed audio signal, the mid-side rebalance comprising:
determining a mid and side ratio of the processed audio signal;
determining a mid-side ratio difference between the mid and side ratio of the processed audio signal and a mid-side ratio of the target acoustic image metric; and
adjusting a mid or side audio signal of the processed audio signal to reduce the mid-side ratio difference.

13. The method claim 1, further comprising performing timbre adjustment of the processed audio signal, the timbre adjustment comprising:
determining a spectral energy level for at least one frequency band of the processed audio signal;
determining a spectral energy level for at least one frequency band of the input audio signal;
determining for each of the at least one frequency band a timbre difference between the spectral energy level of the processed audio signal and the input audio signal of the at least one frequency band; and
applying a timbre gain to the to the at least one processed audio signal based on the timbre difference, the timbre gain reducing the timbre difference.

14. The method according to claim 1, the method further comprising pre-processing the input audio signal, wherein the pre-processing comprises:
determining a total signal level across all frequency bands of each channel in the input audio signal;
determining a pre-processing difference based on a difference between the total signal level for each channel; and
applying, based on the pre-processing difference, a pre-processing gain to at least one of the channels of the input audio signal to reduce the pre-processing difference.

15. The method according to claim 14, wherein the input audio signal comprises a set of consecutive frames, and wherein determining a total signal level for each channel comprises:
determining the mean, median or n-th root of the average of the n-th power of the total signal level for the frames of each channel.

16. The method according to claim 1, wherein the target acoustic image metric has been determined as the average acoustic image metric of the set of reference audio signals comprising the specific type of audio content.

17. The method according to claim 1, wherein the specific type of audio content is music, preferably a specific music genre.

18. The method according to claim 1, wherein said at least one frequency band is at least two frequency bands.

19. The method according to claim 18, further comprising:
combining the at least two frequency bands of the processed audio signal into a full-band processed audio signal.

19. (canceled)

20. A non-transitory computer-readable storage medium storing a computer program including instructions which, when executed by a computer, causes the computer to:
obtain a stereo input audio signal comprising a specific type of audio content;
determine, from at least one frequency band of the input audio signal, at least one acoustic image metric of the input audio signal, the at least one acoustic image metric indicating a channel level difference or correlation between the two channels of the input audio signal in the at least one frequency band;
obtain, for each frequency band, a target acoustic image metric, the target acoustic metric being determined from a set of reference stereo audio signals, each reference audio signal comprising the specific type of audio content;
determine, for each frequency band, a difference metric based on a difference between the acoustic image metric and the target acoustic image metric;
determine, for each frequency band and based on said difference metric, an audio processing scheme to be applied to decrease the difference metric; and
process, each frequency band of the input audio signal with the audio processing scheme to obtain a processed audio signal.

21. (canceled)

22. An audio processing system, comprising a processor connected to a memory, wherein the processor is configured to:
obtain a stereo input audio signal comprising a specific type of audio content;
determine, from at least one frequency band of the input audio signal, at least one acoustic image metric of the input audio signal, the at least one acoustic image metric indicating a channel level difference or correlation between the two channels of the input audio signal in the at least one frequency band;
obtain, for each frequency band, a target acoustic image metric, the target acoustic metric being determined from a set of reference stereo audio signals, each reference audio signal comprising the specific type of audio content;
determine, for each frequency band, a difference metric based on a difference between the acoustic image metric and the target acoustic image metric;
determine, for each frequency band and based on said difference metric, an audio processing scheme to be applied to decrease the difference metric; and
process, each frequency band of the input audio signal with the audio processing scheme to obtain a processed audio signal.
